(19) United States
(12) Patent Application Publication
(10) Pub. No.: US 2012/0044491 A1
(43) Pub. Date: Feb. 23, 2012

(54) OPTICAL FILTER, OPTICAL FILTER MODULE, SPECTROMETRIC INSTRUMENT, AND OPTICAL APPARATUS

(75) Inventors: Tatsuo URUSHIDANI, Chino (JP); Yasushi MATSUNO, Matsumoto (JP)

(73) Assignee: SEIKO EPSON CORPORATION, Tokyo (JP)

(21) Appl. No.: 13/209,835

(22) Filed: Aug. 15, 2011

(30) Foreign Application Priority Data
Aug. 17, 2010 (JP) 2010-182120

(51) Int. Cl. G01J 3/28; G02B 5/28

(52) U.S. Cl. 356/326; 359/578

(57) ABSTRACT

An optical filter includes a first substrate, a second substrate facing the first substrate, a first optical film provided to the first substrate, and a second optical film provided to the second substrate and facing the first optical film, and at least one of the first optical film and the second optical film has a metal film having a reflecting property and transmissibility of a light in a desired wavelength band, and a surface and an edge portion of the metal film is covered by a dielectric film. It is also possible to provide a tilted surface to an edge portion of the metal film. Further, it is also possible to form a step-like bump between the metal film and a dielectric film as another optical film formed under the metal film.

### BACKGROUND

1. Technical Field

The present invention relates to an optical filter, an optical filter module, a spectrometric instrument, an optical apparatus, and so on.

2. Related Art

As an optical film (a reflecting film functioning as a mirror) in an etalon filter, there can be used a metal film and a dielectric multilayer film. It is preferable for the optical film to have both of superior reflectance characteristics and transmissibility in the wavelength range of the light used therein, and taking this condition into consideration, silver (Ag) or alloys thereof with small film thickness are strong candidates as a metal film.

JP-A-2009-251105 discloses an optical filter device configured with an etalon element having a pair of optical films facing each other via a gap. In the optical filter device described in JP-A-2009-251105, the optical film is formed of a silver alloy film including carbon.

In the case of using a metal film as the optical film in the etalon filter or the like, the characteristics of the metal film might be deteriorated due to oxidization, sulfurization, and so on in some cases. For example, a thin film made of silver or an alloy thereof is promising as a candidate of the optical film, but is problematically inferior in heat resistance and environment resistance. In particular, in the case of performing a heat treatment in the manufacturing process of the etalon filter or the like, since oxidization and sulfurization are promoted under the heating environment, it is important to prevent the deterioration of the characteristics of the optical film.

### SUMMARY

An advantage of some aspects of the invention is to prevent the characteristics of a metal film from being deteriorated due to oxidization or sulfurization.

(1) According to one aspect of the invention, there is provided an optical filter including a first substrate, a second substrate facing the first substrate, a first optical film provided to the first substrate, and a second optical film provided to the second substrate and facing the first optical film, wherein at least one of the first optical film and the second optical film has a metal film having a reflecting property and transmissibility of a light in a desired wavelength band, and a surface and an edge portion of the metal film is covered by a dielectric film as a barrier film.

According to the present aspect of the invention, by covering the surface and the end portion of the metal film by the dielectric film as the barrier film, it becomes possible to block a gas and so on to be the causes of degradation of the reflectivity of the metal film such as oxygen, water, or sulfur. Therefore, the deterioration of the characteristics of the optical film can be prevented.

(2) According to another aspect of the invention, in the optical filter of the above aspect of the invention, a material of the metal film is one selected from a first group consisting of Ag as a simple substance, an alloy including Ag as a principal constituent, Au as a simple substance, an alloy including Au as a principal constituent, Cu as a simple substance, and an alloy including Cu as a principal constituent, and the dielectric film as the barrier film is one selected from a second group consisting of an Al oxide film, an Al nitride film, an Si oxide film, an Si nitride film, a Ti oxide film, a Ti nitride film, a Ta oxide film, a Ta nitride film, an ITO film, and an Mg fluoride film, and a laminate film of one oxide film and one nitride film selected from the second group.

The simple metals or the alloys of the metals included in the first group are promising as a candidate of the optical film. The dielectric films included in the second group have an effect of blocking gases causing oxidization, sulfurization, and so on, heat resistance, and light transmissibility, and can therefore function as the barrier film for the metal film.

(3) According to another aspect of the invention, in the optical filter of the above aspect of the invention, a tilted surface is provided to the edge portion of the metal film, and the dielectric film as the barrier film is formed on the tilted surface.

According to the present aspect, the tilted surface is provided to the edge portion (the end portion) of the metal film. The thickness of the dielectric film as the barrier film tends to be thinner in the vicinity of the metal film. The covering property of the barrier film is improved by providing a tapered shape to the edge portion (the end portion) of the metal film. Therefore, it is possible to prevent the problem that in the vicinity of the edge portion of the metal film, the metal film is exposed, or the thickness of the barrier film becomes extremely thin.

(4) According to another aspect of the invention, in the optical filter of the above aspect of the invention, at least one of the first optical film and the second optical film includes the metal film, and another optical film disposed between the metal film and one of the first substrate and the second substrate, an area of the metal film in a plan view viewed from a thickness direction of one of the first substrate and the second substrate is smaller than an area of the another optical film to thereby form a step-like bump between the metal film and the another optical film, and the dielectric film as the barrier film is formed so as to cover the step-like bump.

There are some cases in which a dielectric film as another optical film is disposed under the metal film in order for, for example, improving the reflectivity. In these cases, the total thickness of the optical film as a whole becomes thicker, and there is a possibility of degrading the covering property of the dielectric film as the barrier film in particular in the edge portion. Therefore, in the present aspect of the invention, the area of the metal film is set to be smaller than the area of the dielectric film to thereby form the step-like bump. Therefore, the coverage of the barrier film in the bump section is improved, and the problem that the edge portion of the metal film is exposed is made difficult to occur.

(5) According to another aspect of the invention, in the optical filter of the above aspect of the invention, either one of the first optical film and the second optical film has a metal film having transmissibility of a light in a desired wavelength band, and a surface and an edge portion of the metal film is covered by a dielectric film as a barrier film, and the other optical film is composed of at least one layer of dielectric film as an optical film.

According to the present aspect of the invention, the optical film provided to either one of the substrates and the optical film provided to the other thereof are made different from each other in the material used. Either one of them is made as the optical film including the metal film, and the other thereof is made as the optical film composed only of the dielectric film (including the dielectric multilayer film). Thus, a reflective characteristic, which cannot be obtained by the combination of the dielectric films, can be realized. For example, the bandwidth of the spectral band of the optical filter can be broadened.

(6) According to another aspect of the invention, in the optical filter of the above aspect of the invention, the optical filter is a variable-gap etalon filter, the first substrate has a first electrode, the second substrate has a second electrode, a gap between the first optical film and the second optical film is variably controlled by an electrostatic force generated between the first electrode and the second electrode, and a spectral band is switched in the desired wavelength band in accordance with the control of the gap.

As described above, the metal film is covered by the dielectric film as the barrier film not only in the surface but also in the edge portion. Therefore, the deterioration (e.g., oxidization and sulfurization) of the reflectivity of the metal film due to the causes including moisture can be prevented. Therefore, it becomes possible to maintain the function as a reflecting mirror having the light transmissibility in the Fabry-Perot etalon filter for a long period of time compared to the case in which the metal film is exposed.

(7) According to another aspect of the invention, in the optical filter of the above aspect of the invention, the first electrode is formed in a periphery of the first optical film in a plan view viewed in a direction of a thickness of the first substrate, the second electrode is formed in a periphery of the second optical film in a plan view viewed in a direction of a thickness of the second substrate, and the dielectric film as the barrier film also functions as a protective film covering one of the first electrode and the second electrode.

According to the present aspect of the invention, in the case in which the electrode (including the wiring line) is disposed in the periphery of the metal film as the optical film, the dielectric film as the barrier film is formed so as to cover both of the metal film and the electrode. In the present aspect, the dielectric film as the barrier film functions also as a protective film for the electrode (the wiring line). Since the protective film is provided to the drive electrode, the deterioration of the electrode (the wiring line) can also be prevented.

(8) According to one aspect of the invention, there is provided an optical filter module including the optical filter according to either one of the aspects described above, and a light receiving element adapted to receive a light transmitted through the optical filter.

The optical filter module can be used as, for example, a receiving section (including the light receiving optical system and the light receiving element) of an optical communication device, and can further be used as, for example, the light receiving section (including the light receiving optical system and the light receiving element) of the spectrometric instrument. According to the present aspect of the invention there can be realized, for example, an optical filter module having high reliability, capable of obtaining a broad wavelength range of the transmitted light, small in size, and superior in usability.

(9) According to one aspect of the invention, there is provided a spectrometric instrument including a light receiving element adapted to receive a light transmitted through the optical filter, and a signal processing section adapted to perform a predetermined signal processing based on a signal processing based on a signal obtained by the light receiving element.

According to the present aspect of the invention, a spectrometric instrument having the optical film the characteristics of which is prevented from being deteriorated and high reliability can be realized. The signal processing section performs a predetermined signal processing based on the signal (light reception signal) obtained from the light receiving element to thereby measure the spectrophotometric distribution of the sample, for example. By measuring the spectrophotometric distribution, the colorimetry of the sample, the componential analysis of the sample, and so on can be performed.

(10) According to one aspect of the invention, there is provided an optical apparatus including the optical filter according to either one of the aspects of the invention described above.

Thus, the optical apparatus (e.g., a variety of types of sensors and applied apparatuses of the optical communication) having the optical film the characteristics of which are prevented from being deteriorated, and having high reliability can be realized.

### BRIEF DESCRIPTION OF THE DRAWINGS

The invention will be described with reference to the accompanying drawings, wherein like numbers reference like elements.

FIGS. 1A through 1D are diagrams showing an example of a mirror structure in an optical filter.

FIGS. 2A through 2C are diagrams for explaining an example of a specific structure of a variable-gap etalon element and an operation thereof.

FIGS. 3A through 3C are diagrams for explaining another example of a specific structure of a variable-gap etalon element and an operation thereof.

FIGS. 4A and 4B are diagrams showing an example of the structure of an optical filter using the variable-gap etalon element.

FIG. 5 is a block diagram showing the schematic configuration of a transmitter of a wavelength division multiplexing system as an example of an optical apparatus.

### DESCRIPTION OF EXEMPLARY EMBODIMENTS

Hereinafter, some preferred embodiments of the invention will be described in detail. It should be noted that the present embodiments explained below do not unreasonably limit the content of the invention as set forth in the appended claims, and all of the constituents set forth in the present embodiments are not necessarily essential as means of the invention for solving the problems.

### First Embodiment

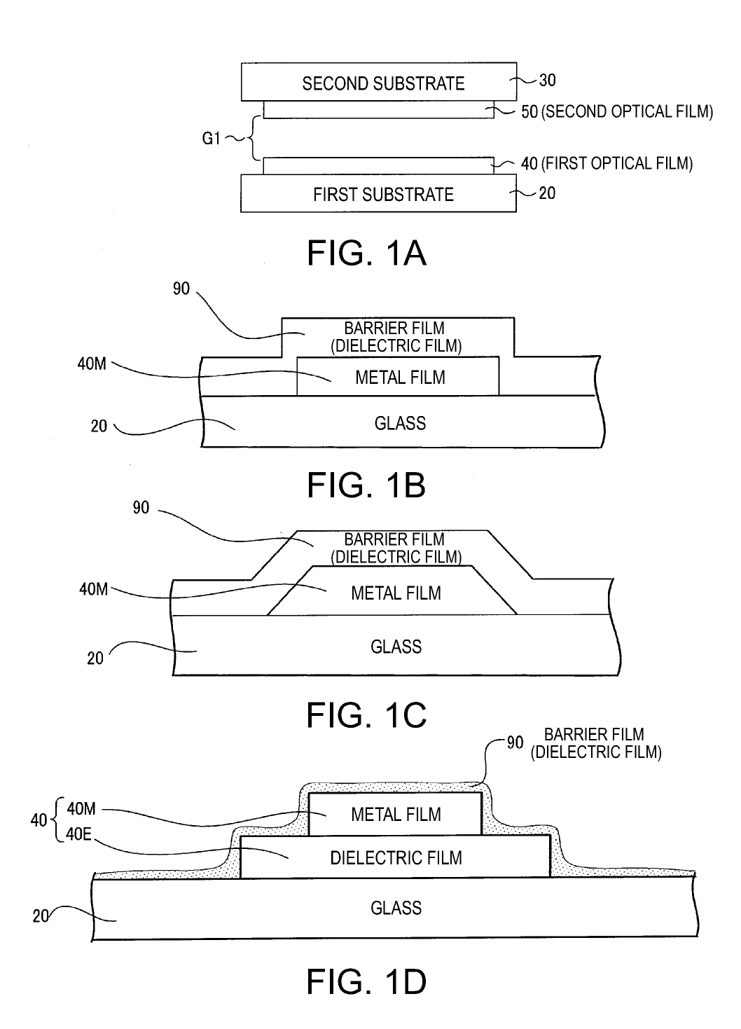

FIGS. 1A through 1D are diagrams showing an example of a mirror structure in an optical filter. As shown in FIG. 1A, an optical filter 300 using a Fabry-Perot etalon element (hereinafter simply referred to as an etalon element) has a first substrate 20 and a second substrate 30 held in parallel to each other, a first optical film (a reflecting film) 40 disposed on the first substrate 20, and a second optical film (a reflecting film) 50 disposed on the second substrate 30. The first substrate 20 or the second substrate 30 is, for example, a glass substrate having transmissibility of the light in a desired wavelength band.

Further, the first optical film (the reflecting film) 40 and the second optical film (the reflecting film) 50 are formed so as to face each other and have a predetermined gap G1 therebetween. It should be noted that the gap G1 can also be variable. The variable-gap etalon element (the variable-gap etalon filter) will be described later. The first optical film 40 and the second optical filter 50 are provided with both of a reflecting property and a transmitting property, and each constitute a mirror in the optical filter 300.

In the present embodiment, at least one of the first optical film 40 and the second optical film 50 has a metal film. The metal film can be a film made of a simple metal, or a film made of an alloy of metals. For example, a thin film made of silver or an alloy thereof is promising as a candidate of the first optical film 40 and the second optical film 50. However, since the thin film is inferior in heat resistance and environment resistance, the measures to the deterioration of the characteristics become necessary. In particular, in the case of performing a heat treatment in the manufacturing process of the etalon element, since oxidization and sulfurization are promoted under the heating environment, it is important to prevent the deterioration of the characteristics of the first optical film 40 and the second optical film 50.

Therefore, in the present embodiment, as shown in FIGS. 1B through 1D, there is adopted a structure in which the surface and the edge portion of the metal film is covered by a dielectric film as a barrier film (or a protective film). In other words, a mirror structure having a barrier film is adopted in the present embodiment. This mirror structure can be applied to at least one of the first optical film 40 and the second optical film 50. In the following explanation, the first optical film. 40 formed on the first substrate 20 is taken as an example.

In the example shown in FIG. 1B, a simple metal film 40M is used as the first optical film 40. The metal film 40M as a constituent of the first optical film 40 is formed on the first substrate 20 such as a quartz glass substrate. Further, the surface and the edge portion of the metal film 40M are covered by the dielectric film as a barrier film 90. After patterning the metal film 40M, not only the surface of the metal film 40M but also the part further including the edge portion (the end portion) thereof are covered by the dielectric film as the barrier film 90, thereby making it possible to form the mirror structure shown in FIG. 1B.

According to this mirror structure, the metal film 40M is covered and protected by the barrier film 90 in not only the surface but also the edge portion and the entire side surface. Therefore, the offending substances such as oxygen, water, or sulfur that degrades the characteristics (e.g., reflectivity) of the metal film 40M are blocked, and therefore, fails to reach the metal film 40M. Therefore, the deterioration of the metal film 40M can be prevented.

Here, as the material of the metal film 40M, there can be used one selected from silver (Ag) as a simple substance, an alloy including silver (Ag) as a principal constituent, gold (Au) as a simple substance, an alloy including gold (Au) as a principal constituent, copper (Cu) as a simple substance, and an alloy including copper (Cu) as a principal constituent. The simple metal or the alloy of the metal is promising as a candidate of the optical film.

It should be noted that as the alloy including Ag as a principal constituent, there can be used, for example, a silver-samarium-copper alloy (AgSmCu), silver carbide (AgC), a silver-palladium-copper alloy (AgPdCu), a silver-bismuth-copper alloy (AgBiNd), a silver-gallium-copper alloy (AgGaCu), a gold-silver alloy (AgAu), a silver-indium-tin alloy (AgInSn), and a silver-copper alloy (AgCu).

Further, as the dielectric film as the barrier film 90, there can be used one film selected from a group of an aluminum (Al) oxide film, an aluminum (Al) nitride film, a silicon (Si) oxide film, a silicon (Si) nitride film, a titanium (Ti) oxide film, a titanium (Ti) nitride film, a thallium (Ta) oxide film, a thallium (Ta) nitride film, an indium tin oxide (ITO) film, and a magnesium (Mg) fluoride film, or a laminate film of one oxide film and one nitride film selected from the group described above. These dielectric films have an effect of blocking a gas causing oxidization, sulfurization, and so on, heat resistance, and light transmissibility, and can therefore function as the barrier film 90 for the metal film 40M. The materials explained hereinabove can similarly be applied to the embodiments explained below.

Further, if the dielectric film as the barrier film 90 is formed on the metal film 40M, it is preferable not to raise the temperature in the manufacturing process too high. Thus, it is possible to prevent recrystallization of the metal film 40M, and to degradation of the reflectivity. Further, it is preferable not to form the dielectric film as the barrier film 90 so as to have a too large thickness (to form the dielectric film so as to have a small thickness). If the thickness of the barrier film 90 is large, in the case of, for example, using the etalon element as a spectroscope, an unnecessary peak might appear in the spectral intensity distribution in some cases to thereby narrow the bandwidth of the wavelength band in which the dispersion can be performed. Therefore, it is preferable to form the barrier film 90 so as to have a film thickness as thin as possible. For example, in the case of the metal film 40M having a film thickness of 50 nm, it is preferable to form the dielectric film as the barrier film 90 having a film thickness of about 20 nm.

Further, in the example shown in FIG. 1C, the covering property of the barrier film 90 in the vicinity of the edge portion of the metal film 40M is improved. Specifically, in the example shown in FIG. 1C, a tilted surface (a tapered surface) is provided to the edge portion of the simple metal film 40M, and the dielectric film as the barrier film 90 is formed on the tilted surface.

Since the edge portion of the metal film 40M is generally provided with an angle approximated to a right angle with the etching process alone, if the barrier film 90 is formed thereon, the thickness of the barrier film 90 tends to be thinner in the vicinity of the edge portion of the metal film 40M. The covering property of the dielectric film (or the dielectric layer) as the barrier film 90 is improved by tapering the edge portion (the end portion) of the metal film 40M. Therefore, the film thickness of the barrier film 90 in the vicinity of the edge portion (the end portion) of the metal film 40M is stable without a variation similarly to the film thickness thereof on the surface of the metal film 40M. Therefore, the reliability of the barrier film 90 is improved compared to the case in which the metal film 40M is processed vertically by the etching process. Therefore, it is possible to prevent the problem that in the vicinity of the edge portion of the metal film 40M, the metal film is exposed, or the thickness of the barrier film 90 becomes extremely thin to thereby degrade the barrier property. As described above, according to the example shown in FIG. 1C, it is possible to obtain the preferable coverage of the edge portion while reducing the film thickness of the dielectric film as the barrier film 90.

Further, as the method of forming the tilted surface (the tapered surface) in the edge portion of the metal film 40M, the following methods, for example, can be adopted. For example, the metal material is sputtered in the condition in which a metal mask is mounted on the first substrate 20. On this occasion, the tapered surface is formed as a result due to a wraparound phenomenon of the metal material in the opening of the mask. Further, for example, a resist is formed on the metal film 40M while reducing the adhesiveness using a method such as lowering the temperature in the post-bake process. In this condition, the metal film 40M is etched using a wet-etching process or an isotropic dry-etching process. A material the etching rate of which is not so high is used as the etchant. Since the etchant infiltrates the interface between the metal film 40M and the resist to thereby advance the etching in a lateral direction, the tapered surface can be formed in the edge portion (the end portion) of the metal film 40M as a result.

In the example shown in FIG. 1D, a dielectric film (a dielectric multilayer film can also be adopted) 40E as another optical film is disposed under the metal film 40M in order for improving the reflectivity and so on. In other words, the dielectric film 40E as the constituent of the first optical film is formed between the metal film 40M as a constituent of the first optical film and the first substrate 20. In the case of adopting this structure, if the area of the metal film 40M in a plan view viewed from the thickness direction of the first substrate 20 is made to coincide with the area of the dielectric film 40E, there is a possibility of degrading the covering property of the dielectric film as the barrier film 90 in particular in the edge portion since the total film thickness of the entire first optical film is large. In order for preventing this problem, it is required to increase the film thickness of the dielectric film as the barrier film 90, which might exert substantial influence to the characteristics of the first optical film 40 in some cases.

Therefore, in the example shown in FIG. 1D, the area of the metal film 40M in the plan view viewed from the thickness direction of the first substrate 20 is set to be smaller than the area of the dielectric film 40E as the first optical film 40 to thereby form a step-like bump. Therefore, the coverage of the barrier film 90 in the bump section is improved, and the problem that the edge portion (the end portion) of the metal film 40M is exposed is made difficult to occur. Further, the film thickness of the dielectric film as the barrier film 90 can be reduced, and therefore, the design of the first optical film 40 is easy.

Further, in the example shown in FIG. 1D, the dielectric film 40E as a constituent of the first optical film formed under the metal film 40M can be a dielectric multilayer film including, for example, at least one pair of TiO₂/SiO₂ films. On this occasion, as the dielectric film as the barrier film 90, an SiO₂ film, which is a material having a rather low refractive index, can be used.

Further, in the example shown in FIG. 1A, it is also possible to use an optical film having a metal film as either one of the first optical film 40 and the second optical film 50, and an optical film composed of at least one dielectric film as the other thereof. In other words, it is also possible to make the optical film provided to either one of the substrates and the optical film provided to the other thereof different from each other in the material used. In this case, a reflective characteristic which cannot be obtained by the combination of the dielectric films can be realized.

Specifically, the wavelength band in which the reflectance peak is obtained is broadened with the metal films alone, and the wavelength band in which the reflectance peak is obtained is narrow with the dielectric films alone. If the etalon element is provided by combining the both types of films, the reflective characteristic of the etalon element as a whole is determined by, for example, the product of the reflectance values of the both types of films. Therefore, the reflective characteristic which cannot be obtained by the combination of the dielectric films alone can be realized, and thus the freedom of design of the optical film in the etalon element is enhanced. For example, the bandwidth of the spectral band of the optical filter can be broadened. It should be noted that since the influence reaches the half bandwidth of the etalon element, the element design taking the influence into consideration is required.

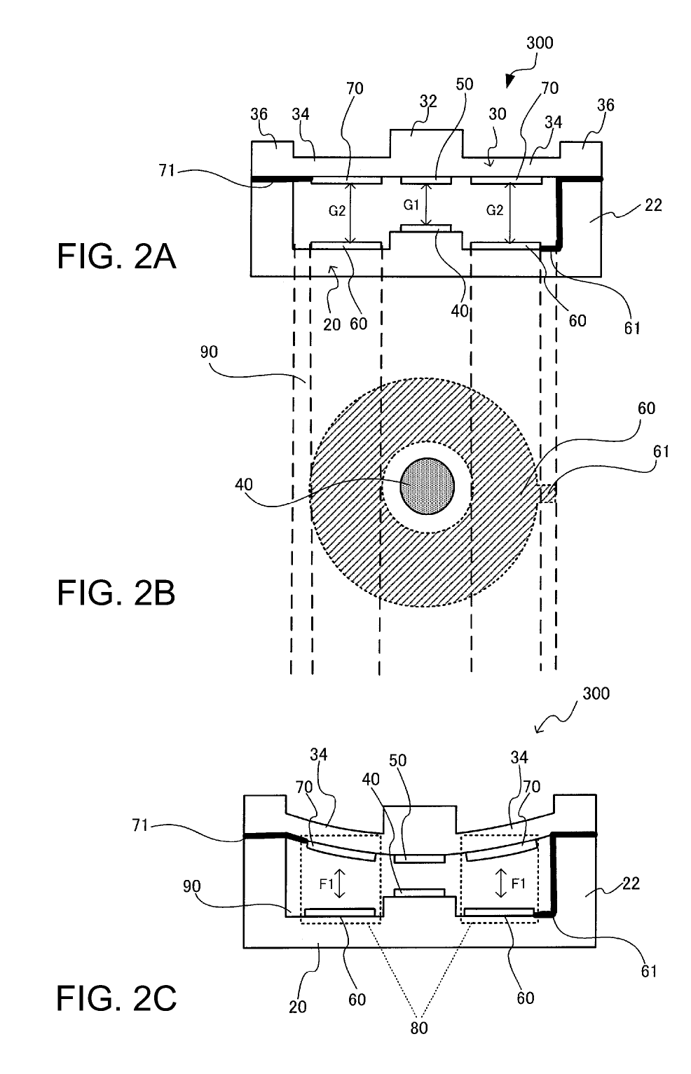

Then, a specific structural example of the variable-gap etalon element will be explained. FIGS. 2A through 2C are diagrams for explaining an example of a specific structure of the variable-gap etalon element and an operation thereof. FIG. 2A is a diagram showing a cross-sectional structure of the variable-gap etalon element in the state (an initial gap G1) in which no drive voltage is applied. Further, FIG. 2B is a diagram showing a layout example of the first optical film 40 and the first electrode 60 formed on the first substrate 20. FIG. 2C is a diagram showing a cross-sectional structure of the variable-gap etalon element in the state (a gap G3) in which the drive voltage is applied. The mirror structure shown in either one of FIGS. 1B through 1D is applied to the variable-gap etalon element (an optical filter) 300 shown in FIGS. 2A and 2B.

In FIG. 2A, there is provided a support section 22 formed, for example, integrally with the first substrate 20, and for movably supporting the second substrate 30. The support section 22 can also be provided to the second substrate 30, or can be formed separately from the first substrate 20 and the second substrate 30.

The first substrate 20 and the second substrate 30 are each made of a variety of types of glass such as soda glass, crystalline glass, quartz glass, lead glass, potassium glass, borosilicate glass, or alkali-free glass, a quartz crystal, or the like. Among these materials, the glass containing an alkali metal such as sodium (Na) or potassium (K) is preferable as the constituent material of each of the substrates 20, 30, and by forming the substrates 20, 30 using such glass materials, the adhesiveness with the optical films (the reflecting films) 40, 50, and the first electrode 60 and the second electrode 70, and the bonding strength between the substrates can be improved. Further, these two substrates 20, 30 are bonded by, for example, surface activated bonding with a plasma-polymerized film to thereby be integrated with each other. Each of the first substrate 20 and the second substrate 30 is formed to have a square shape, for example, 10 mm on a side, and the greatest diameter of the part functioning as a diaphragm is, for example, 5 mm.

The first substrate 20 is formed by, for example, processing a glass substrate, which is formed to have a thickness of 500 μm, by etching.

It should be noted that the second substrate 30 as a movable substrate has a thin wall section (a diaphragm) 34 and thick wall sections 32, 36. Since the thin wall section 34 is provided, a desired deflection (deformation) can be generated in the second substrate 30 with a lower drive voltage. Therefore, low power consumption can be achieved.

The first substrate 20 is provided with the first optical film 40 having, for example, a circular shape formed on a first facing surface at a central portion of the facing surface facing the second substrate 30. Similarly, the second substrate 30 is formed by processing a glass substrate, which is formed to have a thickness of, for example, 200 μm, by etching. The second substrate 30 is provided with a second optical film 50 having, for example, a circular shape facing the first optical film 40 formed at a central position of a facing surface facing the first substrate 20.

It should be noted that the first optical film 40 and the second optical film 50 are each formed to have, for example, a circular shape with a diameter of about 3 mm. The first optical film 40 and the second optical film 50 each can be composed of a metal film made of, for example, AgC having a narrow half bandwidth of transmittance and preferable resolution, and a dielectric film as the barrier film 90 for covering the metal film. The first optical film 40 and the second optical film 50 can be formed using a process such as sputtering. Each of the optical films is formed to have a thickness dimension of, for example, 0.03 μm. In the present embodiment, an optical film having a characteristic capable of performing dispersion in the entire visible light range, for example, can be used as the first optical film 40 and the second optical film 50.

The first optical film 40 and the second optical film 50 are disposed so as to face each other via a first gap (the initial gap) G1 in the non-voltage application state shown in FIG. 2A. It should be noted that although it is assumed here that the first optical film 40 is a fixed mirror, and the second optical film 50 is a movable mirror, it is also possible to reverse the relationship, or to assume the both as movable mirrors.

In a plan view viewed from the thickness direction of the first substrate 20, the first electrode 60 is formed in the periphery of the first optical film 40. It should be noted that in the following explanation, the plan view denotes the case of viewing the substrate plane in the substrate thickness direction of the respective substrates. Similarly, the second electrode 70 is formed on the second substrate 30 so as to face the first electrode 60. The first electrode 60 and the second electrode 70 are disposed so as to face each other via a second gap G2. It should be noted that each of the surfaces of the first electrode 60 and the second electrode 70 can be covered by an insulating film.

As shown in FIG. 2B, the first electrode 60 does not overlap the first optical film 40 in the plan view. Therefore, the optical characteristics of the first optical film 40 can easily be designed. The same can be applied to the second electrode 70 and the second optical film 50.

Further, by applying the common potential (e.g., the ground potential) to the second electrode 70 and the voltage to the first electrode 60, the electrostatic force (here, the electrostatic attractive force) F1 indicated by the arrow can be generated between the electrodes as shown in FIG. 2C. In other words, the first electrode 60 and the second electrode 70 constitute an electrostatic actuator 80. The gap between the first optical film 40 and the second optical film 50 can be controlled variably to be a gap (G3) smaller than the initial gap (G1) due to the electrostatic attractive force F1. The wavelength of the transmitted light is determined in accordance with the dimension of the gap between the optical films. Therefore, it becomes possible to select the transmission wavelength by varying the gap.

It should be noted that as indicated by the thick lines in FIG. 2A, a first wiring line 61 is connected to the first electrode 60, and a second wiring line 71 is connected to the second electrode 70.

As described above, in the present embodiment, the metal film constituting at least one of the first optical film 40 and the second optical film 50 is covered by the dielectric film as the barrier film not only in the surface but also in the edge portion. Therefore, the deterioration (e.g., oxidization and sulfurization) of the reflectivity of the metal film due to the causes including moisture can be prevented. Therefore, it becomes possible to maintain the function as a reflecting mirror having the light transmissibility in the variable-gap etalon element for a long period of time compared to the case in which the metal film is exposed. Therefore, the reliability of the variable-gap etalon element is enhanced.

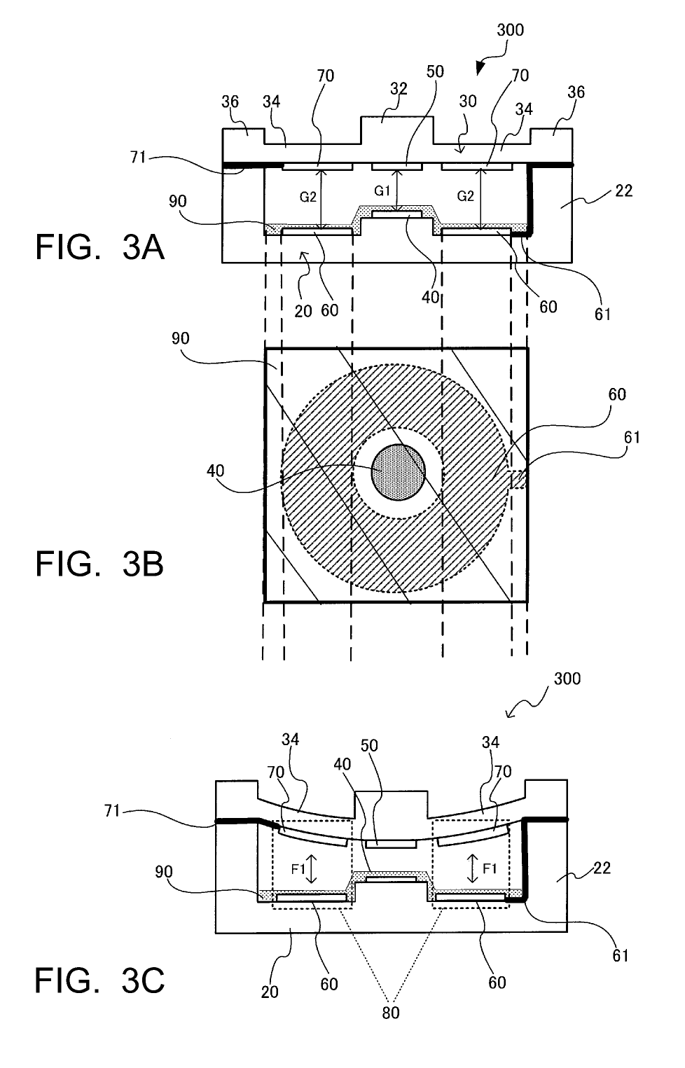

FIGS. 3A through 3C are diagrams for explaining another example of a specific structure of the variable-gap etalon element and an operation thereof. In FIGS. 3A through 3C, the parts common to FIGS. 2A through 2C are denoted with the same reference numerals.

The structure of the variable-gap etalon element shown in FIGS. 3A through 3C is the same as the structure shown in FIGS. 2A through 2C. It should be noted that the barrier film 90 is formed also on the first electrode 60 in the example shown in FIGS. 3A through 3C. In this example, the barrier film 90 functions as the protective film of the first electrode 60. The barrier film 90 can also be disposed on the second substrate 30 side. It should be noted that since the second substrate 30 is a movable substrate, and it is preferable to assure preferable deflection characteristics, the barrier film 90 is disposed on the first substrate 20 side alone in the present embodiment.

As shown in FIG. 3B, the first electrode 60 is formed on the first substrate 20 in the periphery of the first optical film 40 in the plan view viewed from the thickness direction of the first substrate 20, the dielectric film (e.g., an SiO₂ film) as the barrier film 90 shown in FIGS. 1B to 1D functions also as the protective film covering the first electrode 60. Further, in the example shown in FIG. 3B, the dielectric film as the barrier film 90 is formed also on the wiring line 61 connected to the first electrode 60. In other words, the barrier film 90 functions also as a protective film for the wiring line 61.

As described above, in the case in which the electrode and the wiring line are disposed in the periphery of the metal film as the optical film, the dielectric film (e.g., the SiO₂ film) as the barrier film 90 is formed so as to cover both of the metal film and the electrode (including the wiring line). Since the protective film is disposed on the electrode and the wiring line, deterioration of the electrode and the wiring line can also be prevented, and therefore, the reliability of the variable-gap etalon element is further enhanced.

It should be noted that as shown in FIG. 3C, since in the present embodiment the barrier film 90 is not disposed on the second substrate 30 side, the movability (flexibility) of the second substrate 30 is not affected.

### Second Embodiment

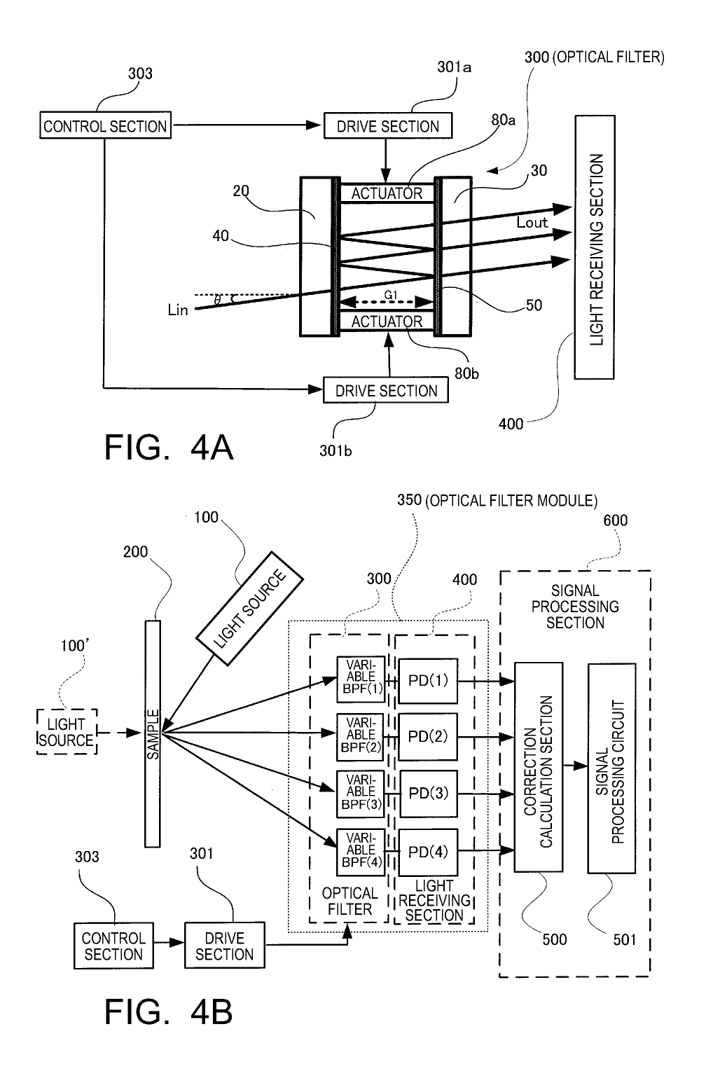

FIGS. 4A and 4B are diagrams showing an example of the structure of an optical filter using the variable-gap etalon element. As shown in FIG. 4A, the variable-gap etalon element as an optical filter 300 has a first substrate (e.g., a fixed substrate) 20 and a second substrate (e.g., a movable substrate) 30 disposed so as to face each other, a first optical film 40 disposed on a principal surface (the obverse surface) of the first substrate 20, a second optical film 50 disposed on a principal surface (the obverse surface) of the second substrate 30, and actuators (e.g., electrostatic actuators and piezoelectric elements) 80a, 80b sandwiched by the substrates and adapted to control the gap (the distance) between the substrates.

It should be noted that it is sufficient that at least one of the first substrate 20 and the second substrate 30 is the movable substrate, and it is also possible to arrange that the both substrates are movable substrates. The actuators 80a, 80b are driven by drive sections (drive circuits) 301a, 301b, respectively. Further, the operation of the drive sections (drive circuits) 301a, 301b is controlled by a control section (a control circuit) 303.

The light Lin entering from the outside at a predetermined angle θ passes through the first optical film 40 while being hardly scattered. The reflection of the light is repeated between the first optical film 40 provided to the first substrate 20 and the second optical film 50 provided to the second substrate 30 to thereby cause the interference of light, and thus only the light having the wavelength fulfilling a specified condition is reinforced, and a part of the light with the wavelength thus reinforced passes through the second optical film 50 on the second substrate 30 to reach the light receiving section (the light receiving element) 400. The wavelength of the light reinforcing each other due to the interference depends on the gap G1 between the first substrate 20 and the second substrate 30. Therefore, it is possible to vary the wavelength band of the light to be transmitted by variably controlling the gap G1.

By using the variable-gap etalon element, the spectrometric device as shown in FIG. 4B can be configured. It should be noted that as an example of the spectrometric device there can be cited, for example, a colorimetric instrument, a spectrometric analyzer, and a spectro spectrum analyzer.

In the spectrometric device shown in FIG. 4B, in the case of performing the colorimetry of a sample 200, for example, a light source 100 is used, and further, in the case of performing the spectrometric analysis of the sample 200, a light source 100′ is used.

The spectrometric device has the light source 100 (or 100′), the optical filter (a dispersion section) 300 provided with a plurality of wavelength variable band-pass filters (variable BPF(1) through variable BPF(4)), a light receiving section 400 including light receiving elements PD(1) through PD(4) such as photodiodes, a signal processing section 600 for performing a predetermined signal processing based on the light reception signals (light intensity data) obtained from the light receiving section 400 to thereby obtain the spectrophotometric distribution and so on, the drive section 301 for driving each of the variable BPF(1) through the variable BPF(4), and the control section 303 for variably controlling the spectral band of each of the variable BPF(1) through the variable BPF(4). The signal processing section 600 has a signal processing circuit 501, and can further be provided with a correction calculation section 500 if necessary. By measuring the spectrophotometric distribution, the colorimetry of the sample 200, the componential analysis of the sample 200, and so on can be performed. Further, as the light source 100 (100′), there can be used a light source (a solid-state light emitting element light source) using a solid-state light emitting element such as an incandescent bulb, a fluorescent lamp, a discharge tube, and an LED.

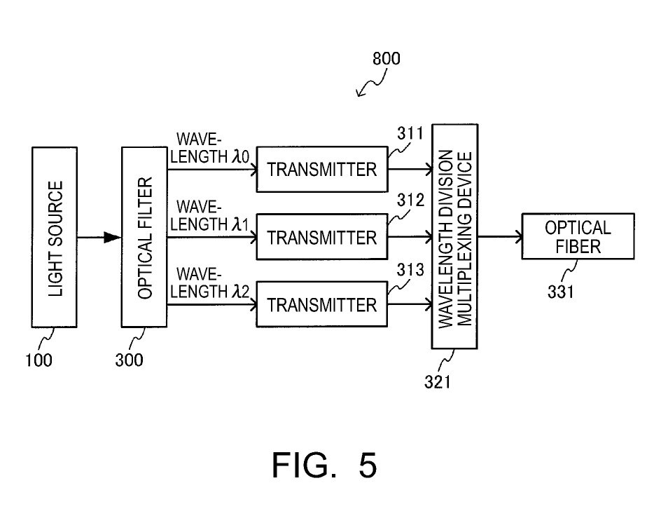

It should be noted that the optical filter 300 and the light receiving section 400 constitute an optical filter module 350. The optical filter module 350 can be applied to the spectrometric device, and can further be used as, for example, a light receiving section (including a light receiving optical system and a light receiving element) of an optical communication device. This example will be described later with reference to FIG. 5. The optical filter module 350 according to the present embodiment has an advantage that the deterioration of the characteristics of the optical film is prevented and therefore high reliability is obtained, and further, the wavelength range of the transmitted light can be set broader, downsizing and weight reduction can be achieved, and at the same time superior usability can be provided.

### Third Embodiment

FIG. 5 is a block diagram showing the schematic configuration of a transmitter of a wavelength division multiplexing system as an example of an optical apparatus. In the wavelength division multiplexing (WDM) communication, using the property of the light that the signals with respective wavelengths different from each other do not interfere each other, by using a plurality of light signals with respective wavelengths different from each other in a single optical fiber in a multiplexed manner, it becomes possible to increase the data transmission quantity without expanding the optical fiber lines.

In FIG. 5, a wavelength division multiplexing transmitter 800 has an optical filter 300 to which alight from the light source 100 is input, and a plurality of lights with respective wavelengths λ0, λ1, λ2, . . . is transmitted through the optical filter 300 (provided with the etalon element to which either one of the mirror structures described above is adopted). Transmitters 311, 312, and 313 are provided corresponding to the respective wavelengths. Optical pulse signals corresponding to a plurality of channels output from the transmitters 311, 312, and 313 are combined by a wavelength division multiplexing device 321 into one signal, and then output to one optical fiber transmission channel 331.

The invention can also be applied to an optical code division multiplexing (OCDM) transmitter in a similar manner. This is because although in the OCDM the channels are discriminated by pattern matching of encoded optical pulse signals, the optical pulses constituting the optical pulse signals include light components with respective wavelengths different from each other. As described above, by applying the invention to the optical apparatus, the optical apparatus (e.g., a variety of types of sensors and applied apparatuses of the optical communication) having the optical film the characteristics of which are prevented from being deteriorated, and having high reliability can be realized.

As described above, by covering not only the surface of the metal film but also the end portion thereof with the dielectric film, it becomes possible to prevent the deterioration (e.g., oxidization and sulfurization) of the reflectivity of the metal film due to the causes including moisture to thereby maintain the function as the reflecting mirror having light transmissibility in the Fabry-Perot etalon element for a long period of time compared to the case in which the metal film is exposed.

As explained hereinabove, according to at least one of the embodiments of the invention, the characteristics of the metal film as an optical film can be prevented from being deteriorated due to oxidization or sulfurization. The invention is preferably applied to a wavelength-variable interference filter such as an etalon element. It should be noted that the invention is not limited to this example, but can also be applied to all of the structures (elements and apparatuses) using the metal film having both of the light reflecting property and the light transmissibility as the mirror structure.

Although the invention is hereinabove explained along some embodiments, it should easily be understood by those skilled in the art that various modifications not substantially departing from the novel matters and the effects of the invention are possible. Therefore, all of such modified examples should be included in the scope of the invention. For example, a term described at least once with a different term having a broader sense or the same meaning in the specification or the accompanying drawings can be replaced with the different term in any part of the specification or the accompanying drawings.

The entire disclosure of Japanese Patent Application No. 2010-182120, filed Aug. 17, 2010 is expressly incorporated by reference herein.

What is claimed is:

1. An optical filter comprising:
a first substrate;
a second substrate facing the first substrate;
a first optical film having a reflecting property and transmissibility of a light in a desired wavelength band, provided to the first substrate; and
a second optical film having a reflecting property and transmissibility of a light in a desired wavelength band, provided to the second substrate and facing the first optical film,
wherein at least one of the first optical film and the second optical film has a metal film, and
a surface and an edge portion of the metal film is covered by a dielectric film.

2. The optical filter according to claim 1, wherein
the dielectric film is a barrier film.

3. The optical filter according to claim 1, wherein
a material of the metal film is one selected from a first group comprising of Ag as a simple substance, an alloy including Ag as a principal constituent, Au as a simple substance, an alloy including Au as a principal constituent, Cu as a simple substance, and an alloy including Cu as a principal constituent, and
the dielectric film is one selected from a second group comprising of an Al oxide film, an Al nitride film, an Si oxide film, an Si nitride film, a Ti oxide film, a Ti nitride film, a Ta oxide film, a Ta nitride film, an ITO film, and an Mg fluoride film, and a laminate film of oxide film or nitride film selected from the second group.

4. The optical filter according to claim 1, wherein
a tilted surface is provided to the edge portion of the metal film, and
the dielectric film is formed on the tilted surface.

5. The optical filter according to claim 1, wherein
at least one of the first optical film and the second optical film includes the metal film, and another optical film disposed between the metal film and one of the first substrate and the second substrate,
an area of the metal film in a plan view viewed from a thickness direction of one of the first substrate and the second substrate is smaller than an area of the another optical film to thereby form a step between the metal film and the another optical film, and
the dielectric film is formed so as to cover the step-like bump.

6. The optical filter according to claim 1, wherein
either one of the first optical film and the second optical film is formed as the optical film having the metal film, and
the other optical film is formed as an optical film composed of at least one layer of dielectric film.

7. The optical filter according to claim 1, wherein
the optical filter is a variable-gap etalon filter,
the first substrate has a first electrode,
the second substrate has a second electrode,
a gap between the first optical film and the second optical film is variably controlled by an electrostatic force generated between the first electrode and the second electrode, and
a spectral band is switched in the desired wavelength band in accordance with the control of the gap.

8. The optical filter according to claim 6, wherein
the first electrode is formed in a periphery of the first optical film in a plan view viewed in a direction of a thickness of the first substrate, and
the second electrode is formed in a periphery of the second optical film in a plan view viewed in a direction of a thickness of the second substrate.

9. An optical filter module comprising:
the optical filter according to claim 1; and
a light receiving element adapted to receive a light transmitted through the optical filter.

10. A spectrometric instrument comprising:
the optical filter according to claim 1;
a light receiving element adapted to receive a light transmitted through the optical filter; and
a signal processing section adapted to perform a predetermined signal processing based on a signal processing based on a signal obtained by the light receiving element.

11. An optical apparatus comprising:
the optical filter according to claim 1.

12. An optical filter comprising:
a pair of reflectors having facing each other,
wherein at least one of the reflector has a metal film, and
a surface and an edge portion of the metal film is covered by a dielectric film.
